(19) United States
(12) Patent Application Publication
(10) Pub. No.: US 2008/0223895 A1
(43) Pub. Date: Sep. 18, 2008

(54) COMBUSTION-POWERED TOOL WITH IMPROVED IGNITION STARTING FEATURE

(75) Inventor: Haruhisa Fujisawa, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Koki Co., Ltd.

(21) Appl. No.: 12/048,282

(22) Filed: Mar. 14, 2008

(30) Foreign Application Priority Data
Mar. 15, 2007 (JP) P2007-066162

(51) Int. Cl. B27F 7/00; B27F 7/05

(52) U.S. Cl. 227/2; 227/10

(57) ABSTRACT

A combustion-powered driving tool for driving nails or other fasteners includes a push lever, a push switch, a trigger switch, a combustion chamber, a sparkplug, and a control section. The push switch is provided for detecting that the push lever is pressed against the workpiece and outputs a first signal indicative of a pressed condition. The trigger switch is provided for instructing to drive the fastener into the workpiece. The trigger switch outputs a second signal indicative of an instruction to drive the fastener. The sparkplug is exposed in the combustion chamber and ignites a mixture of air and flammable gas in the combustion chamber to create a driving force for driving the fastener into the workpiece. The control section is responsive to the first signal and the second signal and commences an igniting operation of the sparkplug at a timing after expiration of a prescribed period of time staring from a timing at which the first signal is output from the push switch.

### BACKGROUND OF THE INVENTION

1. Field of the Invention

The present invention relates to combustion-powered tools, and more particularly to a combustion-powered fastener-driving tool for driving nails or other fasteners. In such a fastener-driving tool, liquefied gas contained in a gas tank is injected into a combustion chamber, where the liquefied gas is mixed with air and ignited. The power generated from this combustion drives a piston, which in turn drives the nail or other fastener into a workpiece.

2. Description of Related Art

Combustion-powered tools of the type described above are disclosed in Japanese Patent Publication (B2) Nos. S64-009149; H01-034753, H04-048589, Japanese Patent No. 3,651,988, and U.S. Pat. Nos. 4,483,474 and 5,133,329. A typical combustion-powered tool primarily includes a housing, handle, trigger switch, head cap, combustion chamber frame, push lever, cylinder, piston, driver blade, motor, fan, gas tank, sparkplug, exhaust check valve, magazine, and tail cover. The head cap seals one end of the housing. The handle is fixed to the housing and includes a trigger switch, as well as a built-in battery. The combustion chamber frame is disposed inside the housing and is capable of moving in the lengthwise direction thereof. A spring urges the combustion chamber frame in a direction away from the head cap, but the frame is capable of opposing the urging force of the spring to contact the head cap with an end nearest the same.

The push lever is movably disposed on the opposite end of the housing from the head cap and is coupled with the combustion chamber frame. The cylinder is fixed to the housing at a position enabling the cylinder to be in fluid communication with the combustion chamber frame for guiding the movement of the frame. Exhaust holes are formed in the cylinder. The piston is capable of sliding in a reciprocating motion in the cylinder. When the end of the combustion chamber frame contacts the head cap, a combustion chamber is formed by the head cap, the combustion chamber frame, the cylinder, and the end of the cylinder nearest the head cap. The driver blade extends from the side of the piston opposite the combustion chamber to the other end of the housing. The motor is supported on the head cap. The fan is positioned in the combustion chamber and fixed to the motor. When driven by the motor, the fan accelerates combustion by creating a turbulent flow with respect to combusted gas, non-combusted gas, and air in the combustion chamber. The fan also introduces outside air into the housing when the combustion chamber frame separates from the head cap to clear gas out of the combustion chamber frame and functions to cool the peripheral sides of the cylinder. The gas tank is accommodated in the housing and contains a liquefied flammable gas that can be injected into the combustion chamber via a channel formed in the head cap. The sparkplug is exposed in the combustion chamber for igniting the mixture of flammable gas and air. The exhaust check valve selectively covers the exhaust holes.

The magazine is disposed on the end of the housing opposite the head cap and accommodates nails or other fasteners. The tail cover is provided between the magazine and the push lever for supplying a fastener from the magazine to a position aligned with the driver blade.

In order to hermetically seal the combustion chamber when the combustion chamber frame contacts the head cap, a sealing member (seal ring) is provided one on a prescribed surface of the head cap that contacts the top part of the combustion chamber frame and one on the edge of the cylinder on the head cap side that contacts the bottom of the combustion chamber frame.

When the push lever is pressed against a workpiece, the combustion chamber is formed; a push switch detects that the push lever is pressed against the workpiece; liquefied gas from the gas tank mounted in the housing is injected into the combustion chamber; and the fan mixes air with the flammable gas. If the trigger switch is operated at this time, the sparkplug ignites the gas-air mixture, causing explosive combustion. This combustion drives the piston and, consequently, the driver blade, to drive a nail into a workpiece, such as wood. More specifically, the combustion-powered tool is provided with a controller for firing the sparkplug when the output from the push switch indicates that the push lever is pressed against the workpiece and the output from the trigger switch indicates that the trigger switch is operated or turned ON.

The combustion chamber frame is maintained in contact with the head cap for a prescribed time after the explosive combustion. After exhausting the gas, the exhaust check valve is closed to seal the combustion chamber, and a thermal vacuum is obtained on the combustion chamber side when a drop in temperature causes the pressure in the combustion chamber to drop. As a result, the piston rises due to the pressure differential above and below the piston.

Control of the sparkplug conventionally performed by the controller will be described with reference to the flowchart shown in FIG. 4. The flowchart indicates “S” as an abbreviation of “step”, “Y” as an abbreviation of “YES”, and “N” as an abbreviation of “NO”.

When the trigger switch is turned ON (step 101: YES), an oscillator is turned ON (step 102). The oscillator is maintained ON for a first predetermined period of time, for example, for 40 milliseconds. When the first predetermined period of time has expired (step 103: YES), the oscillator is turned OFF (step 104). During the first predetermined period of time when the oscillator is ON, an ignition capacitor is charged. Upon the oscillator being turned OFF, a thyristor is turned ON for a second predetermined period of time, for example, for 10 milliseconds (steps 105, 106). Turning the thyristor ON causes the ignition capacitor to discharge. The sparkplug is fired when the discharge current flows. The mixture of flammable gas and air confined in the combustion chamber is ignited by the sparkplug, and explosive combustion drives the fastener into the workpiece. When the trigger switch is turned OFF continuously for, for example, 10 milliseconds (step 107: YES), the above-described operations are repeatedly executed.

The conventional combustion-powered tool is involved with the following drawbacks. If the user presses the push lever against the workpiece and operates the trigger switch at the same time, injection of flammable gas into the combustion chamber and mixture of flammable gas with air cannot be completed before the trigger switch is operated. Note that the injection of flammable gas into the combustion chamber is started when the push switch is turned ON. The same is true with respect to mixing the flammable gas with air by the fan. Consequently, ignition to the mixture of flammable gas and air results in failure and hence driving the fastener into the workpiece cannot be performed. Such a failure operation is liable to occur when ambient temperature is low and the battery voltage for driving the motor is lowered. When the ambient temperature is low, the liquefied fuel cannot be easily vaporized. On the other hand, when the battery voltage is lower than the rated voltage, the fan coupled to the driving shaft of the motor cannot rotate at a regular speed so that a longer time is required to completely mix the flammable gas with air. As described, operability of the conventional combustion-powered tool is unsatisfactory for the users, particularly for those who are not accustomed to use the tool.

### SUMMARY OF THE INVENTION

In view of the foregoing, it is an object of the present invention to provide a combustion-powered tool having an excellent operability assuring the user to drive fasteners under any circumstances.

In order to achieve the above and other objects, there is provided according to one aspect of the invention a combustion-powered driving tool for driving fasteners into a workpiece. The tool includes: a push lever; a push switch; a trigger switch; a combustion chamber; a sparkplug; and a control section. The push switch detects that the push lever is pressed against the workpiece and outputs a first signal indicative of a pressed condition. The trigger switch is provided for instructing driving the fastener into the workpiece and outputs a second signal indicative of an instruction to drive the fastener. The sparkplug is exposed in the combustion chamber and ignites a mixture of air and flammable gas in the combustion chamber to create a driving force for driving the fastener into the workpiece. The controller is responsive to the first signal and the second signal and commences an igniting operation of the sparkplug at a timing after expiration of a prescribed period of time staring from a timing at which the first signal is output from the push switch.

The prescribed period of time may be set to a variety of ways. For example, the prescribed period may be a fixed value, changed depending upon at least one of a battery voltage and ambient temperature, set to a sum of a first time duration set based on the battery voltage and a second time duration set based on the ambient temperature, or set to a first time duration set based on the battery temperature or a second time duration set based on the ambient temperature whichever is longer.

In accordance with another aspect of the invention, there is provided a combustion-powered driving tool for driving fasteners into a workpiece, including: a housing; a head section; a motor; a battery; a cylinder; a piston; a combustion chamber frame; a fan; a sparkplug; a push lever; a push switch; a trigger switch; a temperature sensor; a battery voltage detector; and a controller. The housing has a first end and a second end opposite the first end. The head section is fixed to the first end of the housing and has a flammable gas channel formed therein. The battery is provided for driving the motor. The piston is slidably movably disposed inside the cylinder. The combustion chamber frame moves to contact and separate from the head section and forms a combustion chamber together with the head section, the cylinder, and the piston when the combustion chamber frame is in contact with the head section. The fan is rotatably disposed in the combustion chamber and driven to rotate by the motor. The sparkplug is exposed in the combustion chamber for igniting a mixture of air and flammable gas in the combustion chamber. The flammable gas is supplied into the combustion chamber via the flammable gas channel. Explosive combustion caused by firing of the sparkplug moves the piston toward the second end of the housing and a fastener is driven into the workpiece in accordance with the movement of the piston. The push lever is movably provided to the second end of the housing. The push switch detects that the push lever is pressed against the workpiece and outputs a first signal indicative of a pressed condition. The trigger switch instructs driving the fastener into the workpiece and outputs a second signal indicative of an instruction to drive the fastener. The temperature sensor senses ambient temperature, and the battery voltage detector detects a battery voltage. The controller is responsive to the first signal and the second signal and commences an igniting operation of the sparkplug at a timing after expiration of a prescribed period of time staring from a timing at which the first signal is output from the push switch. The prescribed period of time can be set as described above.

### BRIEF DESCRIPTION OF THE DRAWINGS

The particular features and advantages of the invention as well as other objects will become apparent from the following description taken in connection with the accompanying drawings, in which:

FIG. 1 is a cross-sectional view showing a combustion-powered driving tool according to an embodiment of the invention;

FIG. 2 is a circuit diagram showing a control circuit provided in the combustion-powered driving tool according to the embodiment of the invention;

FIG. 3 is a flowchart showing control of an ignition circuit provided in the combustion-powered driving tool according to the embodiment of the invention; and

FIG. 4 is a flowchart showing control of an ignition circuit provided in a conventional combustion-powered driving tool.

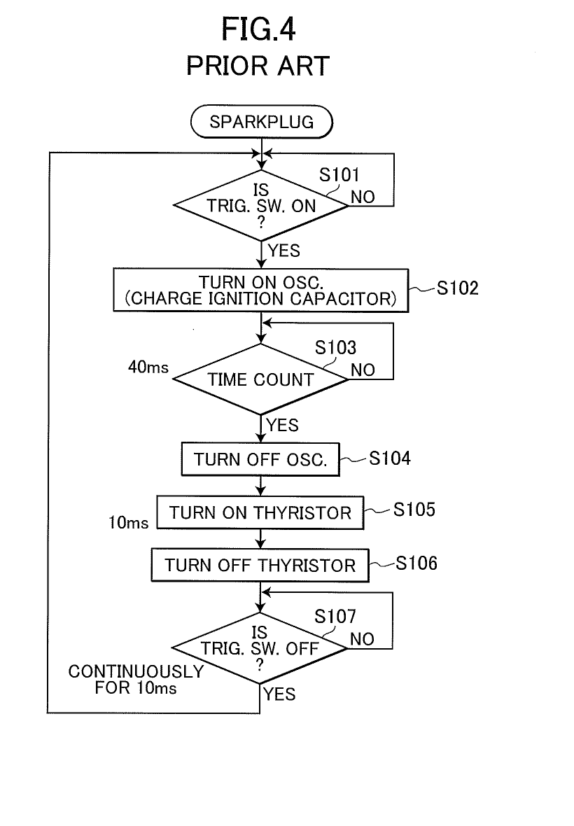

### DETAILED DESCRIPTION OF THE PREFERRED EMBODIMENTS

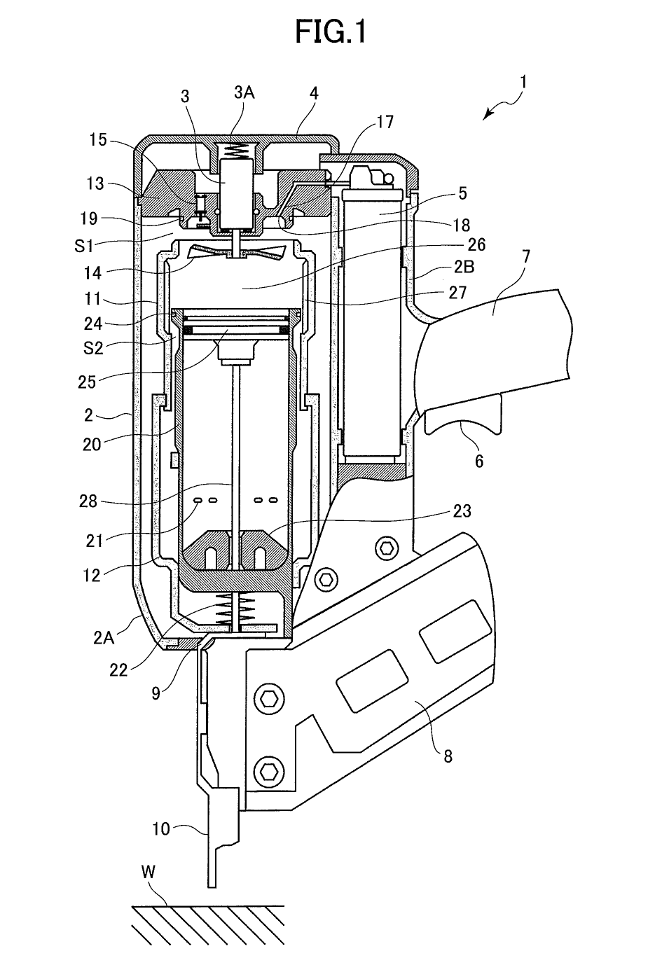

Next, an embodiment of the invention will be described while referring to FIGS. 1 to 3, wherein the combustion-powered tool of the present invention is applied to a combustion-powered, fastener-driving tool. In the following description, it is assumed that the tool is held in an orientation in which nails are fired toward a downward direction.

A combustion-powered, fastener-driving tool 1 has a housing 2 that forms an outer framework. The housing 2 includes a main housing section 2A and a tank chamber 2B provided alongside the main housing section 2A in the lengthwise direction. An intake hole (not shown) is formed in the top of the main housing section 2A, while an exhaust hole (not shown) is formed in the bottom of the same.

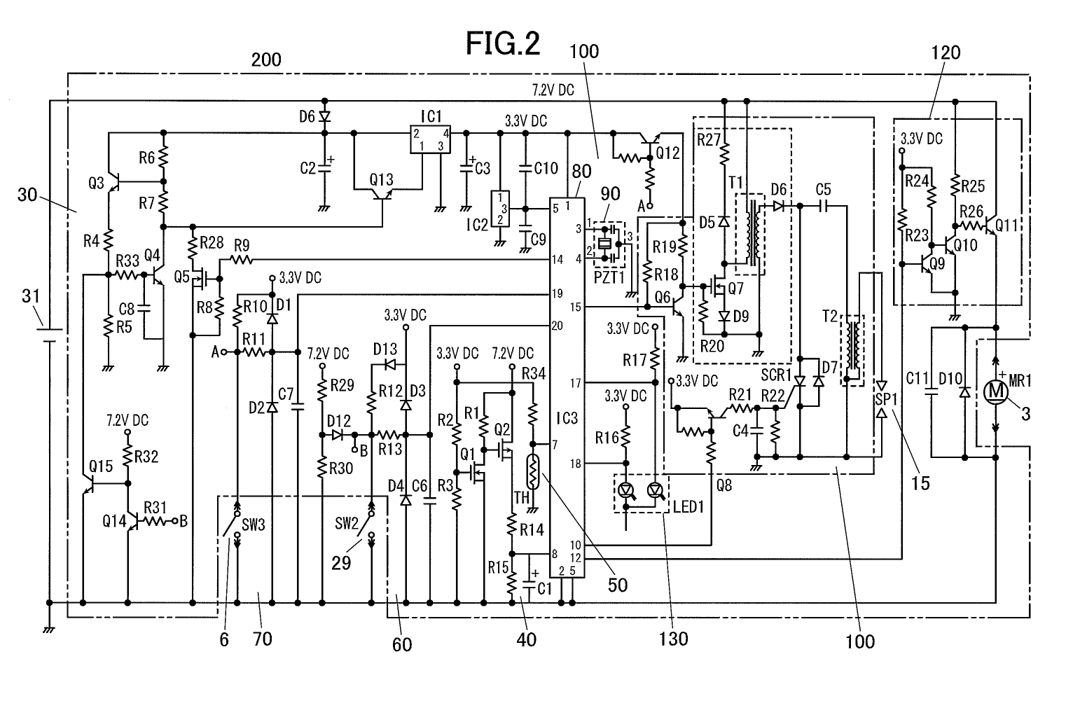

A head cover 4 is mounted on the top of the main housing section 2A. A gas tank 5 containing flammable gas is removably accommodated in the tank chamber 2B. A handle 7 extends outward from the tank chamber 2B. The handle 7 is provided with a trigger switch 6 and a built-in battery 30 (see FIG. 2) having a nominal voltage of 7.2 V, for example. Disposed below the main housing section 2A and the tank chamber 2B are a magazine 8 loaded with nails (not shown) and a tail cover 9 for guiding the nails in the magazine 8 to a prescribed position.

A push lever 10 is movably supported on the bottom end of the main housing section 2A with respect to the position of the nail set by the tail cover 9. A coupling unit 12 fixed to a combustion chamber frame 11 described later is joined to the push lever 10. When the tip of the push lever 10 contacts a workpiece W and the entire housing 2 is pushed in a direction toward the workpiece W, the upper portion of the push lever 10 can recede into the main housing section 2A.

A head cap 13 is fixed in the top end of the main housing section 2A. A motor 3 is supported in the head cap 13 by a spring 3A. A fan 14 is fixed to a rotational shaft of the motor 3. A sparkplug 15 is also retained in the head cap 13. A push switch 29 (see FIG. 2) is provided in the main housing section 2A for detecting that the combustion chamber frame 11 is at the top end of a stroke. In other words, the push switch 29 detects that the push lever 10 is pressed against the workpiece W. When the push lever 10 rises to a prescribed position, the push switch 29 is switched on, activating the motor 3, which in turn begins rotating the fan 14. The fan 14 is configured from a hub and six vanes equally spaced apart around the hub and extending outwardly from the hub. The fan 14 rotates at a rate of approximately 12,000 rpm.

A fuel injection channel 17 is formed in the side of the head cap 13 nearest the tank chamber 2B. An end of the fuel injection channel 17 penetrating the bottom surface of the head cap 13 forms an injection nozzle 18, while the other end forms a connector for connecting to the gas tank 5. A first sealing member 19 formed of an O-ring is mounted on the head cap 13 for forming a seal between the head cap 13 and the combustion chamber frame 11 when the top of the combustion chamber frame 11 is placed in contact with the head cap 13.

The combustion chamber frame 11 disposed in the main housing section 2A is capable of reciprocating movement in the lengthwise direction of the main housing section 2A and is capable of contacting the bottom surface of the head cap 13. As described above, the coupling unit 12 is joined with the push lever 10 and fixed to the bottom end of the combustion chamber frame 11. Accordingly, the combustion chamber frame 11 moves along with the movement of the push lever 10. A cylinder 20 is fixed to the main housing section 2A for guiding movement of the combustion chamber frame 11 by contacting the inner wall of the same. A compressed coil spring 22 is interposed between the bottom surface of the cylinder 20 and the coupling unit 12 for urging the combustion chamber frame 11 away from the head cap 13. Exhaust holes 21 are formed near the bottom of the cylinder 20 and are in fluid communication with the exhaust hole in the main housing section 2A described above. A check valve (not shown) is provided on the outer side of the exhaust holes 21 for selectively blocking the same. A bumper 23 is also provided in the bottom of the cylinder 20. A second sealing member 24 formed of an O-ring is mounted on the top of the cylinder 20 for forming a seal between the inner wall near the bottom of the combustion chamber frame 11 and the outer wall near the top of the cylinder 20 when the combustion chamber frame 11 contacts the head cap 13.

A piston 25 capable of reciprocating movement while sliding against the inner wall of the cylinder 20 is provided inside the cylinder 20. When the top end of the combustion chamber frame 11 contacts the head cap 13, a combustion chamber 26 is formed by the head cap 13, the combustion chamber frame 11, the end of the cylinder 20 nearest the head cap, the piston 25, and the first and second sealing members 19 and 24. When the combustion chamber frame 11 separates from the head cap 13, a first channel S1 in fluid communication with the outside air forms between the head cap 13 and the top end of the combustion chamber frame 11, and a second channel S2 in communication with the first channel S1 forms between the bottom end of the combustion chamber frame 11 and the top end of the cylinder 20. The second channel S2 allows combustion gas and fresh air to pass outside the cylinder 20 and to be discharged through the exhaust hole in the main housing section 2A.

A plurality of ribs 27 is provided on the section of the combustion chamber frame 11 forming the combustion chamber 26, extending in the axial direction of the combustion chamber frame 11 and protruding radially inwardly. In cooperation with the rotation of the fan 14, the ribs 27 promote the mixture of air and flammable gas in the combustion chamber 26 through agitation. The intake hole described above that is formed in the top of the main housing section 2A supplies air into the combustion chamber 26, while combustion gas in the combustion chamber 26 is discharged through the exhaust holes 21 and the exhaust hole formed in the bottom of the main housing section 2A.

A driver blade 28 extends from the side of the piston 25 opposite the combustion chamber 26 to the end of the main housing section 2A. The driver blade 28 is capable of impacting a nail in the tail cover 9 along the same axis as the nail. When propelled downward, the piston 25 collides with the bumper 23 and stops.

The fan 14, spark plug 15, and injection nozzle 18 are all disposed in or exposed in the combustion chamber 26. The fan 14 achieves three functions. First, before the sparkplug 15 fires, rotation of the fan 14 mixes air and flammable gas in the combustion chamber 26 by agitation when the combustion chamber frame 11 is contacting the head cap 13. Second, when the sparkplug 15 fires, rotation of the fan 14 generates a turbulent flow that promotes combustion. Third, when the combustion chamber frame 11 separates from the head cap 13 after driving the nail, the first and second channels S1 and S2 are formed and the fan 14 functions to clear combustion gas from the combustion chamber 26 and to cool the cylinder 20.

As described above, the push switch 29 is turned ON when the push lever 10 is pressed against the workpiece W. When the trigger switch 6 is subsequently operated or turned ON, the sparkplug 15 is fired to ignite the mixture of air and flammable gas in the combustion chamber 26. Explosive combustion slidably moves the piston 25 downwards along the inner wall of the cylinder 20. The driver blade 28 moving together with the piston 25 strikes the nail into the workpiece W. When the trigger switch 6 is thereafter released or turned OFF and the tool 1 is lifted to separate from the workpiece W, the push lever 10 and the combustion chamber frame 11 move downward and returns to the initial position shown in FIG. 1 by virtue of the urging force of the compressed coil spring 22. At this time, the fan 14 keeps rotating for a prescribed period of time after the push switch 29 is turned OFF.

FIG. 2 shows a circuit diagram of a controller assembly 200 according to the embodiment of the invention. The controller assembly 200 is configured from a power source section 30; a battery voltage detecting section 40; an ambient temperature sensing section 50; a push switch section 60; a trigger switch section 70; a microcomputer 80; an oscillator 90; a charge section 100; an ignition circuit section 110; a motor drive controlling section 120; and a display section 500.

The power source section 30 includes a regulator IC1 for generating a drive voltage of the microcomputer 80 and reference voltages, an FET Q5, transistors Q3, Q4, Q13, Q14 and Q15, a diode D8, capacitors C2, C3, C8 and C9, and resistors R4, R5, R6, R7, R8, R9, R28, R31, R32 and R33.

The voltage of the battery 31 (7.2 V) is applied to the regulator IC1 through the diode D8 and the regulator IC1 generates a voltage (3.3 V) for operating the controller assembly 200. The regulator IC1 has a terminal for controlling the output from the regulator IC1. To stop the voltage output from the regulator IC1, the microcomputer 80 outputs a HIGH signal from the terminal 14, causing the FET Q5 to turn ON which in turn causes the transistor Q13 to turn OFF and the transistors Q3 and Q4 to turn ON. Thus, the output stop signal is transmitted to the regulator IC1. When the voltage output from the regulator IC1 is stopped, the output stop signal, which has been supplied from the terminal 14 of the microcomputer 80, is no longer supplied therefrom. However, the transistor Q4 is held ON in the absence of the output stop signal. This condition continues as far as the battery 31 is not removed. Hence, the controller assembly 200 is placed in a low power consumption mode in which the voltage is not output from the regulator IC1. Under the low power consumption mode, the tool is not capable of being operated. The low power consumption mode can be canceled by turning OFF a main switch (not shown) and then turning ON the main switch again.

A reset IC chip IC2 is connected to the terminal 6 of the microcomputer 80 and outputs a reset signal thereto when the battery 31 is loaded and the main switch is turned ON or when the output voltage from the regulator IC1 is out of a set range.

The battery voltage detecting section 40 includes FETs Q1 and Q2, resistors R1, R2, R3, R14 and R15, and a capacitor C1. The resistors R14 and R15 divides the voltage across the battery 31 and the voltage developed across the resistor R15 is applied to terminal 8 of the microcomputer 80.

The ambient temperature sensing section 50 includes a resistor R34 and a thermistor TH. The ambient temperature sensed by the thermistor TH is applied to the microcomputer 80.

The push switch section 60 includes a push switch 29 (SW2), resistors R12, R13, diodes D3, D4 and a capacitor C6. When the tool 1 is pressed against the workpiece W and the push switch 29 (SW2) is turned ON, a LOW signal is applied to the terminal 20 of the microcomputer 80. The push switch 29 (SW2) and the trigger switch 6 (SW3) are provided in positions apart from the substrate of the controller assembly 200 and these switches are connected to the relevant positions using cables.

Here, a problem arises such that the cables pick up noises produced at the time of ignition, resulting in a voltage induced on the cables, which causes the ground side of the push switch 29 (SW2) to be positive in polarity. The diodes D3, D4 are provided so that the induced voltage is applied thereto. Thus, an unduly high voltage can be prevented from being applied to the microcomputer 80.

The trigger switch section 70 includes resistors R10, R11, diodes D1, D2 and a capacitor C7, and operates in a similar fashion to the push switch section 60.

Although not shown in the drawing, the microcomputer 80 has a reset input port, an output port, a central processing unit (CPU), a RAM, a ROM, an analog-to-digital (A/D) converter, a timer, and an input port. The microcomputer 80 controls rotation of the motor 3 and operation of the ignition circuit section 110. An oscillator 90 disposed outside the microcomputer 80 is connected to the timer. While this embodiment uses the microcomputer 80, a digital circuit may be employed in lieu of the microcomputer 80 to achieve the same job imposed on the microcomputer 80.

The charging circuit section 100 is provided for charging an ignition capacitor C5 and includes the ignition capacitor C5, a transformer T1, diodes D5, D6, D9, transistors Q6, Q12, an FET Q7, and resistors R18, R19, R20. Charging the capacitor C5 is commenced when the trigger switch 6 (SW3) is turned ON. An ON signal issued from the trigger switch 6 (SW3) is transmitted via two paths to the charging circuit 100. In the first path, the ON signal is applied to the base of the transistor Q12 to render the latter ON and is thus transmitted to the collector of the transistor Q6. On the other hand, the ON signal transmitted via the second path is applied to the terminal 19 of the microcomputer 80. Upon receipt of the ON signal, the microcomputer 80 outputs a LOW signal intermittently from the terminal 11 to the base of a transistor Q6, thereby ON/OFF switching the transistor Q6. The ON signal transmitted via the two paths causes the FET Q7 to perform ON/OFF switching. As a result, a high voltage is developed across the secondary side of the transformer T1, and the ignition capacitor C5 is charged thereby.

As described above, the charging circuit 100 does not start charging the ignition capacitor C5 if the trigger switch 6 (SW3) is held OFF. This is true even if a voltage developed by a noise is applied to the terminal 19 of the microcomputer 80 and a charge signal is output from the microcomputer 80 instructing to charge the ignition capacitor C5.

The ignition circuit 110 includes an ignition plug 15 (SP1), a thyristor SCR1, a diode D7, and resistors R21, R22. When the thyristor SCR1 is turned ON, electric charges retained in the ignition capacitor C5 are discharged. As a result, the voltage across the secondary side of the transformer T2 is boosted up to about 15,000 V, causing the ignition plug 15 to ignite. The microcomputer 80 operates to apply the ON signal to the gate of the thyristor SCR1 for 10 milliseconds after the ignition circuit is rendered operative.

The motor driving controlling section 120 includes transistors Q9 through Q11 and resistors R23 through R25 and operates when the tool 1 is pressed against the workpiece W and the push switch 29 (SW2) is turned ON. When the push switch 29 (SW2) is turned ON, the microcomputer 80 outputs a LOW signal from the terminal 10, which renders the transistor Q9 OFF and the transistor Q10 ON. As a result, the motor 3 is applied with the battery voltage (7.2 V).

The display section 130 includes a light emitting diode LED1 and a resistor R16. When the battery 3 is loaded into the tool 1 and the main switch is turned ON, HIGH and LOW signals are cyclically generated from the terminal 16 of the microcomputer 80 and a LOW signal is generated from the terminal 15 of the microcomputer 80. Thus, the light emitting diode LED1 flickers with green light to thereby indicate the operator that the tool 1 is in a usable condition. When the tool 1 is pressed against the workpiece W and the motor 3 is driven, the microcomputer 80 generates a LOW signal from the terminal 15 and a HIGH signal from the terminal 16. Then, the light emitting diode LED1 is continuously lit with green light to thereby indicate the operator that the nail driving operation can be started. When the battery voltage is not at a nominal level and the controller assembly 200 is not in the low power consumption mode, the microcomputer 80 generates a HIGH signal from the terminal 15 and a LOW signal from the terminal 16. Then the light emitting diode LED1 is lit with red light to thereby alert the operator that the battery 31 needs charging.

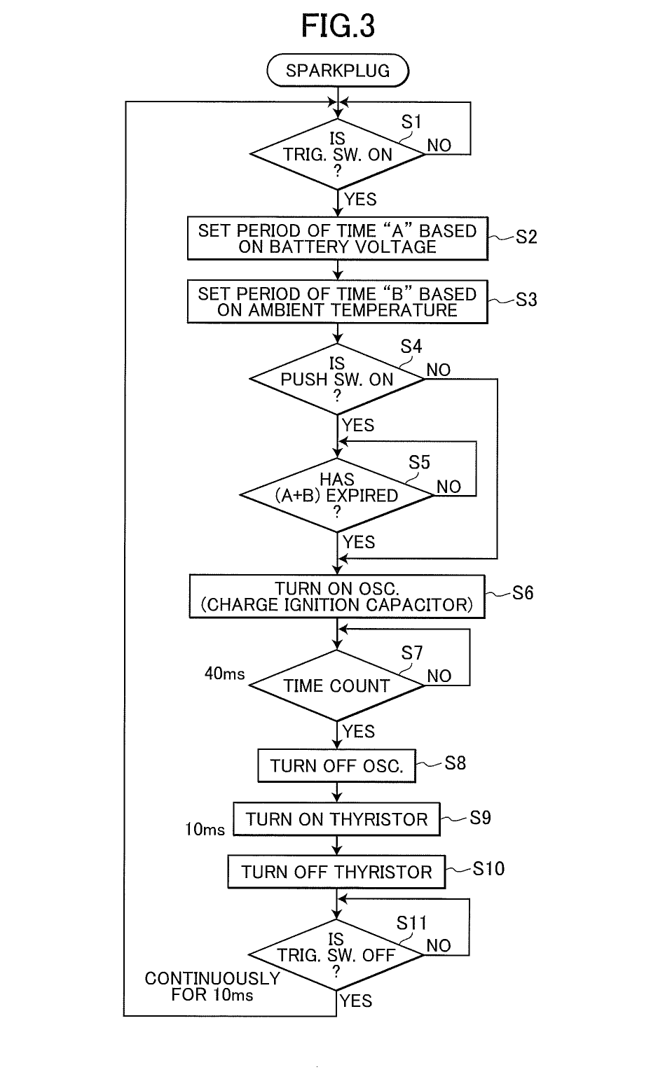

Next, control of the ignition circuit section 110 by the microcomputer 80 will be described while referring to the flowchart shown in FIG. 3. The flowchart indicates “S” as an abbreviation of “step”, “Y” as an abbreviation of “YES”, and “N” as an abbreviation of “NO”.

As will be described later, the ignition circuit section 110 according to this embodiment has a delayed ignition starting feature. Specifically, the ignition circuit section 110 is configured to ignite the mixture of air and flammable gas by the sparkplug 15 after expiration of a predetermined time duration starting from the timing at which the push switch 29 is turned ON.

In the flowchart of FIG. 3, when the trigger switch 6 is turned ON (step 1: YES), a first prescribed period of time A is set based on the battery voltage (step 2) and then a second prescribed period of time B is set based on an ambient temperature (step 3). Then, determination is made as to whether or not the push switch 29 is turned ON (step 4). In this embodiment, the trigger switch 29 is configured not to turn ON if the push switch 29 is not turned ON due to a mechanism provided in association with the push switch 29.

When the push switch 29 is turned ON upon pressing the push lever 10 against the workpiece W (step 4: YES), determination is made as to whether or not a duration of time (A+B) has been elapsed from the timing at which the push switch 29 is turned ON (step 5). When the determination made in step 5 is affirmative (step 5: YES), the oscillator 90 is turned ON (step 6) and then OFF after expiration of a first predetermined period of time (steps 7 and 8). During the first predetermined period of time when the oscillator 90 is turned ON (for example, 40 milliseconds), the ignition capacitor C5 is charged. After the oscillator 90 is turned OFF, the thyristor is turned ON for the second predetermined period of time (for example, 10 milliseconds) for allowing the ignition capacitor C5 to discharge (steps 9 and 10). Discharging the ignition capacitor C5 generates sparks from the sparkplug 15, the mixture of air and flammable gas confined in the combustion chamber 26 is ignited, and a nail is driven into the workpiece W. Thereafter, when the trigger switch 6 is turned OFF (step 11: YES), the aforesaid operations are repeatedly executed.

As described above, in accordance with the embodiment of the invention, the oscillator 90 is held inoperable before expiration of a predetermined period of time (A+B) starting from the timing at which the push switch 29 is turned ON. During this predetermined period of time (A+B) paused before commencement of the igniting operation, the flammable gas and air are sufficiently mixed through agitation. The oscillator 90 becomes operable after sufficient agitation of the flammable gas and air is performed, whereupon the igniting operation to the mixture of air and flammable gas is performed. Accordingly, even if a user not accustomed to use the tool inadequately operated the trigger switch 6 simultaneously with pressing operation of the push lever 10 against the workpiece W, ignition and combustion of the mixture of air and flammable gas are ensured. Under any circumstance which may be affected by ambient temperature, battery voltage and the like, driving of nails into the workpiece W can be commenced accurately when the trigger switch 6 is operated, thereby enhancing the operability of the combustion-powered nail driving tool 1.

Although the invention has been described with respect to a specific embodiment, it will be appreciated by one skilled in the art that a variety of changes and modifications may be made without departing from the scope of the invention.

For example, the above-described embodiment sets a waiting time duration starting from the timing at which the push switch 29 is turned ON to the timing at which the ignition operation is commenced to be a sum of time durations A and B where the first period of time A is set based on the battery voltage and the second period of time B based on the ambient temperature. A modification can be made so that the waiting time duration is set to be the period of time A or B whichever is longer. Alternatively, the waiting time duration may be set to a fixed value that is sufficiently long enough to achieve mixture and agitation of air and flammable gas under the severest condition affected by the ambient temperature and battery voltage.

What is claimed is:

1. A combustion-powered driving tool for driving fasteners into a workpiece, comprising:
a push lever;
a push switch that detects that the push lever is pressed against the workpiece and outputs a first signal indicative of a pressed condition;
a trigger switch that instructs driving the fastener into the workpiece and outputs a second signal indicative of an instruction to drive the fastener;
a combustion chamber;
a sparkplug that is exposed in the combustion chamber and ignites a mixture of air and flammable gas in the combustion chamber to create a driving force for driving the fastener into the workpiece; and
a controller that is responsive to the first signal and the second signal and commences an igniting operation of the sparkplug at a timing after expiration of a period of time staring from a timing at which the first signal is output from the push switch.

2. The combustion-powered driving tool according to claim 1, wherein the period of time is set to a fixed value.

3. The combustion-powered driving tool according to claim 1, wherein the period of time is changed depending upon at least one of a battery voltage and ambient temperature.

4. The combustion-powered driving tool according to claim 3, wherein the period of time is set to a sum of a first time duration set based on the battery voltage and a second time duration set based on the ambient temperature.

5. The combustion-powered driving tool according to claim 1, wherein the period of time is set to a first time duration set based on the battery temperature or a second time duration set based on the ambient temperature whichever is longer.

6. The combustion-powered driving tool according to claim 1, further comprising a motor driven when the first signal is output from the push switch, and a fan rotatably disposed in the combustion chamber and driven by the motor, wherein the fan is driven during the period of time.

7. A combustion-powered driving tool for driving fasteners into a workpiece, comprising:
a housing having a first end and a second end opposite the first end;
a head section for fixing to the first end of the housing and having a flammable gas channel formed therein;
a motor;
a battery for driving the motor;
a cylinder;
a piston slidably movably disposed inside the cylinder;
a combustion chamber frame that moves to contact and separate from the head section and that forms a combustion chamber together with the head section, the cylinder, and the piston when the combustion chamber frame is in contact with the head section;
a fan rotatably disposed in the combustion chamber and driven to rotate by the motor;
a sparkplug exposed in the combustion chamber for igniting a mixture of air and flammable gas in the combustion chamber, the flammable gas being supplied into the combustion chamber via the flammable gas channel, wherein explosive combustion caused by firing of the sparkplug moves the piston toward the second end of the housing and a fastener is driven into the workpiece in accordance with the movement of the piston;
a push lever movably provided to the second end of the housing;
a push switch that detects that the push lever is pressed against the workpiece and outputs a first signal indicative of a pressed condition;
a trigger switch that instructs driving the fastener into the workpiece and outputs a second signal indicative of an instruction to drive the fastener;
a temperature sensor that senses ambient temperature;
a battery voltage detector that detects a battery voltage; and
a controller that is responsive to the first signal and the second signal and commences an igniting operation of the sparkplug at a timing after expiration of a period of time staring from a timing at which the first signal is output from the push switch.

8. The combustion-powered driving tool according to claim 7, wherein the period of time is set to a fixed value.

9. The combustion-powered driving tool according to claim 7, wherein the period of time is changed depending upon at least one of the battery voltage detected by the battery voltage detector and the ambient temperature sensed by the temperature sensor.

10. The combustion-powered driving tool according to claim 7, wherein the period of time is set to a sum of a first time duration set based on the battery voltage detected by the battery voltage detector and a second time duration set based on the ambient temperature sensed by the temperature sensor.

11. The combustion-powered driving tool according to claim 7, wherein the period of time is set to a first time duration set based on the battery voltage detected by the battery voltage detector or a second time duration set based on the ambient temperature sensed by the temperature sensor whichever is longer.

12. The combustion-powered driving tool according to claim 7, wherein the motor is driven when the first signal is output from the push switch, and the fan is driven by the motor during the period of time.
